(19) United States
(12) Patent Application Publication
(10) Pub. No.: US 2026/0334552 A1
(43) Pub. Date: Oct. 29, 2026

(54) AEROSOL GENERATING DEVICE

(71) Applicant: KT&G CORPORATION, Daejeon (KR)

(72) Inventors: Sangkyu PARK, Seoul (KR); Daenam HAN, Seoul (KR)

(73) Assignee: KT&G CORPORATION, Daejeon (KR)

(21) Appl. No.: 19/111,737

(22) PCT Filed: Sep. 18, 2023
(86) PCT No.: PCT/KR2023/014042

§ 371 Date: Mar. 13, 2025

(30) Foreign Application Priority Data
Sep. 19, 2022 (KR) 10-2022-0118185
Dec. 27, 2022 (KR) 10-2022-0185478

(51) Int. Cl. A24F 40/46; H05B 3/10; H05B 3/16

(52) U.S. Cl. CPC A24F 40/46; H05B 3/10; H05B 3/16

(57) ABSTRACT

An aerosol generating device according to the present disclosure includes: a body comprising an insertion space having an opening to allow a stick to be inserted therein; a heater pin protruding from an end of the insertion space toward the opening and configured to be inserted into the stick that is inserted into the insertion space; and a heater disposed in a cavity of the heater pin and configured to heat the heater pin for heating the stick inserted into the insertion space, wherein the heater is formed of a material that has a temperature coefficient of resistance (TCR) value of 1500 ppm/°C or less.

### TECHNICAL FIELD

The present disclosure relates to an aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, three substances contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to precisely control the temperature of a heater.

It is yet another objective of the present disclosure to prevent water or moisture from entering the inside of a heater pin.

It is yet another objective of the present disclosure to prevent a malfunction of a heater.

It is yet another objective of the present disclosure to improve the structural stability of a heater assembly.

### Solution to Problem

According to one aspect of the subject matter described in this application, an aerosol generating device includes: a body comprising an insertion space having an opening to allow a stick to be inserted therein; a heater pin protruding from an end of the insertion space toward the opening and configured to be inserted into the stick that is inserted into the insertion space; and a heater disposed in a cavity of the heater pin and configured to heat the heater pin for heating the stick inserted into the insertion space, wherein the heater is formed of a material that has a temperature coefficient of resistance (TCR) value of 1500 ppm/°C or less.

### Advantageous Effects of Invention

According to at least one of the embodiments of the present disclosure, an aerosol generating device that improves the heater and power efficiency may be provided.

According to at least one of the embodiments of the present disclosure, the temperature of a heater may be precisely controlled.

According to at least one of the exemplary embodiments of the present disclosure, water or moisture may be prevented from entering the inside of a heater pin.

According to at least one of the embodiments of the present disclosure, a malfunction of a heater may be prevented.

According to at least one of the embodiments of the present disclosure, the structural stability of a heater assembly may be improved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 9 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

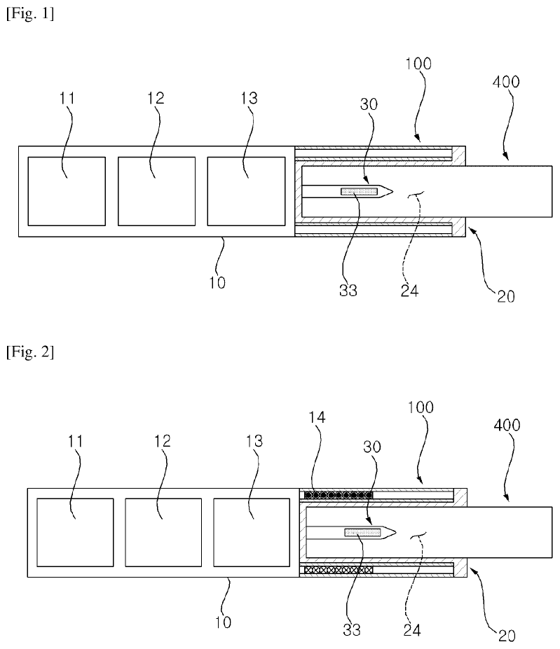

Referring to FIGS. 1 to 3, an aerosol generating device 100 may include at least one of a battery 11, a controller 12, and a sensor 13. At least one of the battery 11, the controller 12, and the sensor 13 may be disposed inside a body 10 of the aerosol generating device 100.

A pipe 20 may be coupled to an upper side of the body 10. The pipe 20 may have an insertion space 24 therein. The insertion space 24 may be open at top. The insertion space 24 may have a cylindrical shape. A stick 400 may be detachably inserted into the insertion space 24.

A heater 33 may be disposed inside a heater pin 30 protruding upward from a cover 25, which defines a bottom of the pipe 20, toward the insertion space 24. The heater 33 may be a resistive heater. The heater 33 may heat the stick 400 inserted into the insertion space 24.

When the stick 400 is inserted into the insertion space 24, one end of the stick 400 may be exposed outward of the insertion space 24 and the body 10. When the stick 400 is inserted into the insertion space 24, the heater 33 may pass through an end portion of the stick 400 to be inserted into the stick 400. The stick 400 may be heated by the heater 33. A user may inhale air while holding the one end of the stick 400 exposed to the outside in his or her mouth.

The battery 11 may supply power to operate components of the aerosol generating device 100. The battery 11 may supply power to at least one of the controller 12, the sensor 13, an induction coil 14, and the heater 33. The battery 11 may supply power required for a display, a motor, and the like installed at the aerosol generating device 100 to operate.

The controller 12 may control the overall operation of the aerosol generating device 100. The controller 12 may control the operation of at least one of the battery 11, the induction coil 14, and the sensor 13. The controller 12 may control the operation of the display, the motor, and the like installed at the aerosol generating device 100. The controller 12 may check the state of each of the components of the aerosol generating device 100 to determine whether the aerosol generating device 100 is in an operable state.

The sensor 13 may sense a temperature of the heater 33. The controller 12 may control the temperature of the heater 33 based on the temperature of the heater 33 sensed by the sensor 13. The controller 12 may transmit, through a user interface, in-formation regarding the temperature of the heater 33 sensed by the sensor 13 to a user.

Referring to FIG. 1, the heater 33 may be electrically connected to the battery 11. The heater 33 may generate heat directly by the use of a current supplied from the battery 11, without the need for the induction coil 14 (see FIG. 2).

Referring to FIG. 2, the aerosol generating device 100 may include the induction coil 14. The induction coil 14 may surround the insertion space 24 and the heater 33. The induction coil 14 may cause the heater 33 to generate heat. The heater 33 may be a susceptor, which may generate heat by a magnetic field produced by an AC current flowing through the induction coil 14. The magnetic field may pass through the heater 33 to thereby generate an eddy current in the heater 33. The current may cause the heater 33 to generate heat.

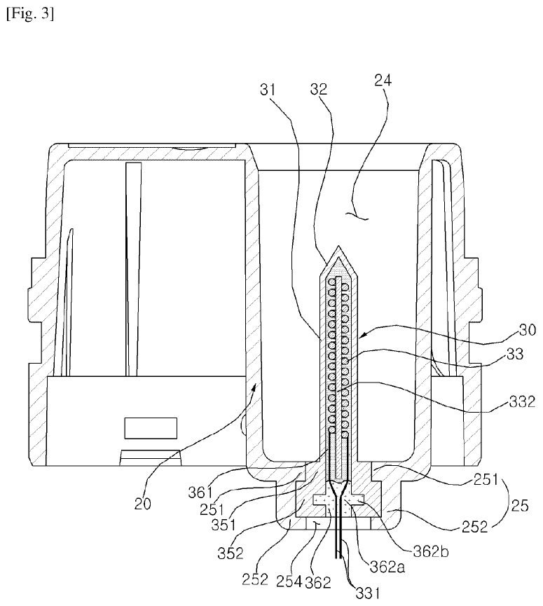

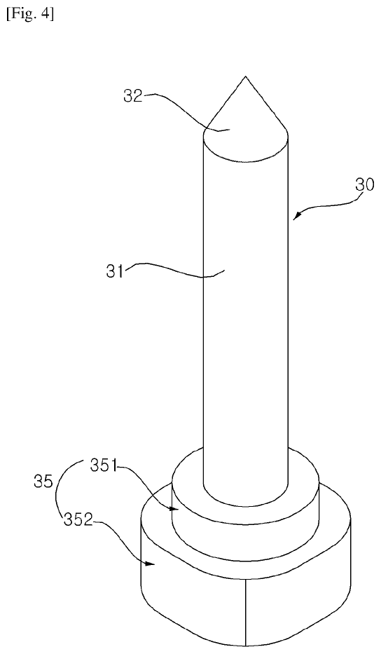

Referring to FIGS. 3 to 5, the pipe 20 may include a cover 25. The cover 25 may define a bottom of the pipe 20, and may cover a lower portion of the insertion space 24. The cover 25 may include a first cover part 251 and a second cover part 252.

The first cover part 251 may be connected to a lower end of the pipe 20. The first cover part 251 may cover a bottom of the insertion space 24. The second cover part 252 may be connected to the first cover part 251. The second cover part 252 may be formed under the first cover part 251. An inner surface of the second cover part 252 may be recessed outward relative to an inner surface of the first cover part 251. A cover hole 254 may be formed in a lower portion 2522 of the second cover part 252. The cover hole 254 may communicate with a cavity (or hollow) 34 of the heater pin 30.

The heater pin 30 may protrude long upward from the bottom of the pipe 20 toward the opening of the insertion space 24. The heater pin 30 may be elongated up and down or vertically. The heater pin 30 may include a cylindrical shape. The heater pin 30 may have a sharp or pointed upper end. The heater pin 30 may be provided therein with a space into which the heater 33 is inserted. The heater pin 30 may be made of a material having excellent moisture resistance and heat resistance. For example, the heater pin 30 may be made of a ceramic material.

The heater pin 30 may include a pin body 31. The pin body 31 may be elongated vertically. The pin body 31 may have a cylindrical shape. An inside of the pin body 31 may define the cavity 34. The heater pin 30 may be open at bottom to communicate with the cavity 34. The cavity 34 may be elongated vertically. The cavity 34 may have a cylindrical shape.

The heater pin 30 may include a pin tip 32. The pin tip 32 may define the upper end of the heater pin 30. The pin tip 32 may be integrally formed on the pin body 31. The pin tip 32 may have a shape that tapers upward. The pin tip 32 may have a sharp or pointed upper end. Accordingly, the heater pin 30 may pass through the stick S to thereby fix the stick S.

A flange 35 may protrude outward from the heater pin 30. The flange 35 may protrude from a lower end of the heater pin 30 in a lateral direction. The flange 35 may protrude from the heater pin 30 in a radially outward direction. The flange 35 may be integrally formed with the heater pin 30.

The flange 35 may be formed of a plurality of tiers. For example, the flange 35 may be formed of two tiers. For example, the flange 35 may include a first flange 351 and a second flange 352. The first flange 351 may be disposed at an upper portion (or top) of the flange 35. The second flange 352 may be disposed at a lower portion (or bottom) of the flange 35. Hereinafter, it will be described that the flange 35 includes the first flange 351 and the second flange 352, but the present disclosure is not limited thereto. The flange 35 may include a greater number of flanges. For example, the flange 35 may be formed of three or more tiers.

The first flange 351 may be disposed on the second flange 352. The first flange 351 may be integrally formed with the second flange 352. The first flange 351 may be disposed at a lower portion of the pin body 31. The first flange 351 may protrude from an outer circumferential surface of the pin body 31 in a laterally outward direction or the radially outward direction. The first flange 351 may extend in a circumferential direction.

The second flange 352 may be disposed underneath the first flange 351. The second flange 352 may be disposed at the lower end of the heater pin 30. The second flange 352 may protrude from the outer circumferential surface of the pin body 31 in the laterally outward direction or the radially outward direction. The second flange 352 may protrude further in the laterally outward direction or the radially outward direction than the first flange 351.

Accordingly, a step (or stepped portion) may exist between the first flange 351 and the second flange 352.

At least one of the first flange 351 and the second flange 352 may have a non-circular cross section. For example, the first flange 351 may extend in the circumferential direction to have a circular cross-sectional shape, and the second flange 352 may have a non-circular cross-sectional shape.

The first cover part 251 may surround and come into close contact with a lateral surface of the first flange 351. The first cover part 251 may cover or come into close contact with an upper surface of the second flange 352. An upper surface of the first flange 351, together with the first cover part 251, may face the bottom of the insertion space 24.

The second cover part 252 may surround and come into close contact with a lateral surface and an outer lower portion of the second flange 352. The second flange 352 may be disposed between the first cover part 251 and the second cover part 252 so as to be supported in an up-and-down direction or a vertical direction.

Accordingly, the cover 25 and the flange 35 may be coupled to each other to be engaged in the vertical direction so as to be supported in the vertical direction. Thus, separation of the heater pin 30 from the pipe 20 may be prevented, and the structural stability may be achieved.

In addition, the cover 25 and the flange 35 may be coupled to each other to be engaged in the circumferential direction. Accordingly, rotation of the heater pin 30 that is coupled to the pipe 20 may be prevented (see FIG. 3).

The pipe 20 may be formed by insert injection molding. A pipe 20 coupled with a heater pin 30 may be produced by inserting the heater pin 30, together with a heater 33, a support bar 332, and a bonding material 361, into a mold for injection of the pipe 20, and removing a lead wire 331 from the mold, and then injecting and solidifying an injection material into the mold.

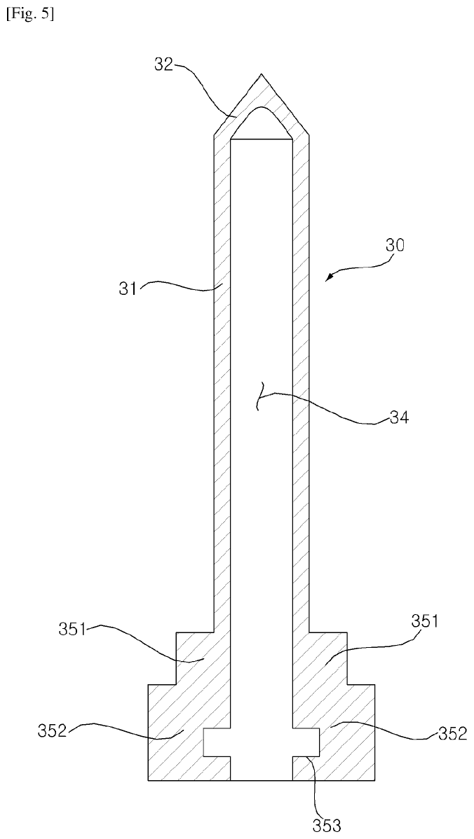

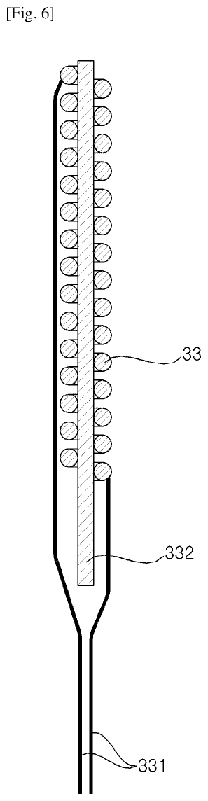

Referring to FIGS. 5 to 7, the heater pin 30 may be open at bottom. A bonding material 361 in a liquid state may be injected into the cavity 34 of the heater pin 30 through an injector. The bonding material 361 may be injected into the cavity 34 while the heater pin 30 is turned upside down or reversed with the opening of the heater pin 30 facing up.

The heater 33 may be a resistive metal. The heater 33 may have a coil shape. The heater 33 may be wound around a support bar 332 that is elongated. The support bar 332 may support the heater 33, so that the heater 33 may be maintained in shape.

A lead wire 331 may extend long from each of both ends of the heater 33. The heater 33 may be supplied with power from a power source through the lead wire 331. The heater 33 may be a resistive heater, which may generate heat using power supplied thereto.

In a state where the heater pin 30 is turned upside down, the heater 33 and the support bar 332 may be inserted into the cavity 34 through the opening at the bottom of the heater pin 30. The heater 33 and the support bar 332 may be inserted into the liquid-state bonding material 361 injected into the cavity 34. The support bar 332 and the heater 33 may be completely submerged in the bonding material 361. As the heater 33 is wound around the support bar 332 and is supported by the support bar 332, the shape of the heater 33 may be maintained when inserted into the bonding material 361. Here, the lead wire 331 may extend from the heater 33 to an outside of the cavity 34 through the opening of the heater pin 30, so as to be exposed below the heater pin 30.

The support bar 332 may be disposed in the cavity 34 to be parallel with the pin body 31. The heater 33 may be disposed between the pin body 31 and the support bar 332 inside the cavity 34. The support bar 332 and the heater 33 may be disposed to be elongated along a direction in which the cavity 34 extends.

The bonding material 361 may fill gaps among the pin body 31, the support bar 332, and the heater 33 in the cavity 34. After the heater 33 and the support bar 332 are inserted into the cavity 34, the bonding material 361 may be dried for a predetermined time and solidified into a solid state. The bonding material 361 may be bonded and fixed to an inner surface of the pin body 31. The bonding material 361 may be bonded and fixed to the heater 33 and the support bar 332. The bonding material 361 may fix or secure the heater 33 and the support bar 332 to the heater pin 30. The bonding material 361 may cover the opening at the bottom of the heater pin 30. The lead wire 331 may pass through the bonding material 361 and the cover hole 254 (see FIG. 3) so as to be exposed downward, and may be connected to the power source.

The heater pin 30 may be formed of a ceramic material. Since the heater pin 30 comes into contact numerous times with the stick 400 in a repeated manner, is elongated, and accommodates the heater 33 therein, the material of the heater pin 30 may be selected in consideration of mechanical strength, abrasion resistance, and heat resistance. For example, the heater pin 30 may be formed of zirconia. Zirconia has the best mechanical strength at room temperature among the ceramics, a melting point of 2000 °C or more, and good hardness and wear resistance. Due to its excellent durability, the heater pin 30 may maintain a stable shape even under repeated heat generation of the heater 33 and repeated contact with the stick 400.

The bonding material 361 may be made of a material that is non-conductive and has excellent heat resistance and chemical resistance. For example, the bonding material 361 may be a ceramic bonding agent (ceramic bond). The ceramic bonding agent may include raw materials such as polyurethane, amine, styrene copolymer, resin, and the like, but are not limited thereto. The bonding material 361 in a liquid state may be solidified after a predetermined time at room temperature, but this may vary depending on the type of raw material constituting the bonding material 361 or the composition ratio of the raw materials. The bonding material 361 may be a ceramic bonding agent that has good compatibility with the heater pin 30 formed of ceramics, making it suitable for bonding the heater pin 30. Also, due to the excellent durability of the bonding material 361, the outer shape may be stably maintained even under repeated heat generation of the heater 33 and repeated contact with the stick 400.

The bonding material 361 may include an alumina ceramic, which may be a ceramic material containing aluminum oxide (Al—₂O₃) as a main component. For example, the content of aluminum oxide in the bonding material 361 may be 80% or more. Thus, the bonding material 361 may have high electrical insulation, high resistance to thermal shock, high thermal conductivity, and excellent mechanical adhesive strength and corrosion resistance. In addition, the bonding material 361 may be suitable for bonding and sealing an inside of the heater pin 30.

The support bar 332 may include aluminum oxide (Al—₂O₃). Aluminum oxide is one of the ceramic raw materials, which has good rigidity, high electrical insulation, chemical stability, good corrosion resistance and heat resistance, and low price. Due to its electrical insulation properties, the support bar 332 may be prevented from being short-circuited with the heater 33, and may allow the heater 33 to be securely fixed with almost no shape deformation when the heater 33 generates heat. In addition, as the support bar 332 has good compatibility with the bonding material 361, the support bar 332 may be easily bonded with the bonding material 361.

The heater pin 30 may further include a depressed portion 353. With respect to a transverse or horizontal direction, an inner surface of the heater pin 30 may be recessed outward from the cavity 34, in the vicinity of the opening of the heater pin 30, to thereby define the depressed portion 253. The inner surface of the heater pin 30 may be recessed in the radially outward direction to define the depressed portion 353. The depressed portion 353 may extend in the circumferential direction. A cross-sectional shape of the depressed portion 353 may be circular, but the present disclosure is not limited thereto. Based on the cross section, a circumference of the depressed portion 353 may be greater than a circumference of the cavity 34.

The bonding material 361 may include a central portion 361a and a protruding portion 361b. The bonding material 361 in a liquid state may be dried into a solid state to form the central portion 361a aligned with the cavity 34. The central portion 361a may have a cylindrical shape. The bonding material 361 in a liquid state may be injected and filled in the depressed portion 353. The liquid-state bonding material 361 injected into the depressed portion 353 may be dried into a solid state. The solid-state bonding material 361 filling the depressed portion 353 may be defined as the protruding portion 361b. The protruding portion 361b may protrude from the central portion 361a in the horizontal direction. The protruding portion 361b may protrude from the central portion 361a in the radially outward direction. The central portion 361a may protrude further vertically than the protruding portion 361b. The central portion 361a and the protruding portion 361b may be bonded to the inner surface of the heater pin 30.

Accordingly, due to the protruding portion 361b, a step (or stepped portion) may be formed in a gap between the central portion 361a and the inner surface of the heater pin 30, thereby preventing liquid from being introduced into a gap between the bonding material 361 and the inner surface of the heater pin 30.

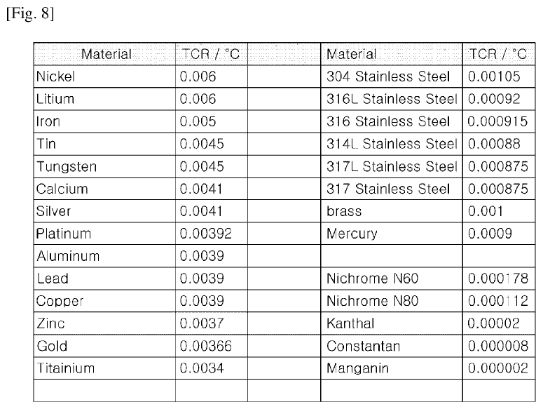

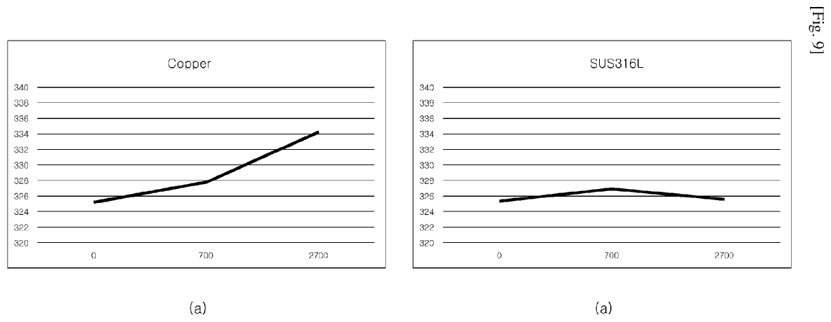

FIG. 8 is a table showing the temperature coefficient of resistance (TCR) of various metals. The TCR value may be expressed in units of/°C or ppm/°C. TCR values of metals may decrease as the temperature of the metals increases. The TCR values described below are values measured at a metal temperature of 50 °C or less.

Nickel and lithium each have a TCR value of 0.006/°C or 6000 ppm/°C. Iron has a TCR value of 0.005/°C or 5000 ppm/°C. Tin and tungsten each have a TCR value of 0.0045/°C or 4500 ppm/°C. Calcium and silver each have a TCR value of 0.0041/°C or 4100 ppm/°C. Platinum has a TCR value of 0.00392/°C or 3920 ppm/°C. Aluminum, lead, and copper each have a TCR value of 0.0039/°C or 3900 ppm/°C. Zinc has a TCR value of 0.0037/°C or 3700 ppm/°C. Titanium has a TCR value of 0.00366/°C or 3660 ppm/°C. Gold has a TCR value of 0.0034/°C or 3400 ppm/°C.

Meanwhile, stainless steel, nichrome, kanthal, constantan, and manganin have high strength, high resistance to corrosion (corrosion proof), high heat resistance with the ability to withstand high temperatures. Stainless steel has a melting point of about 1400 to 1500 °C; Nichrome has a melting point of about 1400 °C; Kanthal has a melting point of about 1500 °C; Constantan has a melting point of about 1260 °C; and Manganin has a melting point of about 960 °C.

Stainless steel has properties of good processability suitable for coil forming, and a high heat generation rate relative to the heat generation area. When a predetermined voltage V is applied to a metal, the lower the resistance value is, the higher the amount of heat generation becomes and the higher the rate of heat generation becomes. The resistivity of stainless steel may be approximately 6.9×10⁻⁷Ω*?*m at 20 °C.

Stainless steel may come in various grades depending on the content of the material used. Stainless steel may be classified into three major groups: ferritic, martensitic, and austenitic, depending on the structure constituting the matrix. Austenitic stainless steel is a type of steel containing a larger proportion of not only chromium but also nickel, which has good formability and corrosion resistance. Austenitic stainless steels may include, for example, 304 stainless steel, 314 stainless steel, 314L stainless steel, 316 stainless steel, 316L stainless steel, 317 stainless steel, 317L stainless steel, and the like, but are not limited thereto. Austenitic stainless steels may generally have similar TCR values. For example, 304 stainless steel has a TCR value of 0.00105/°C or 1050 ppm/°C; 316L stainless steel has a TCR value of 0.00092/°C or 920 ppm/°C; 316 stainless steel has a TCR value of 0.000915/°C or 915 ppm/°C; 314L stainless steel has a TCR value of 0.00088/°C or 880 ppm/°C; and 317L stainless steel and 317 stainless steel each have a TCR value of 0.000875/°C or 875 ppm/°C.

Nichrome has properties of good processability suitable for coil forming, and a high heat generation rate. The resistivity of nichrome is about 1.10×10⁻⁶Ω*?*m at 20 °C. Nichrome may be expressed as N60, N80, and the like depending on the content ratio of nickel to chromium, and the TCR value tends to decrease as the nickel content increases. For example, the TCR value of Nichrome N60 is 0.000178/°C or 178 ppm/°C. As another example, the TCR value of Nichrome N80 is 0.000112/°C or 112 ppm/°C.

Kanthal has a very low TCR value, and thus, the resistance changes very little with temperature. The TCR value of kanthal is 0.00002/°C or 20 ppm/°C. The resistivity of kanthal is about 1.4 X 10-622 * m at 20 °C.

Constantan is an alloy of nickel and copper. Constantan has good processability, a very low TCR value, which means the resistance changes very little with temperature, and a high heat generation rate. The TCR value of constantan is 0.000008/°C or 8 ppm/°C. The resistivity of constantan is about 4.9×10⁻⁷Ω*m at 20 °C.

Manganin is an alloy of copper, manganese, and nickel. Manganin has a very low TCR value, which means the resistance changes very little with temperature, and a high heat generation rate. The TCR value of manganin is 0.000002/°C or 2 ppm/°C. The resistivity of manganin is about 4.82×10⁻⁷Ω*m at 20 °C.

Brass is an alloy of copper and zinc. Brass has a TCR value of 0.0001/°C or 1000 ppm/°C. Brass has a melting point of about 960 °C. The resistivity of brass is about 6.0×10⁻⁸ to 9.0×10⁻⁸Ω*m at 20 °C.

Mercury has a TCR value of 0.0009/°C or 900 ppm/°C. However, since mercury is liquid at room temperature, mercury may not be suitable as a heating element.

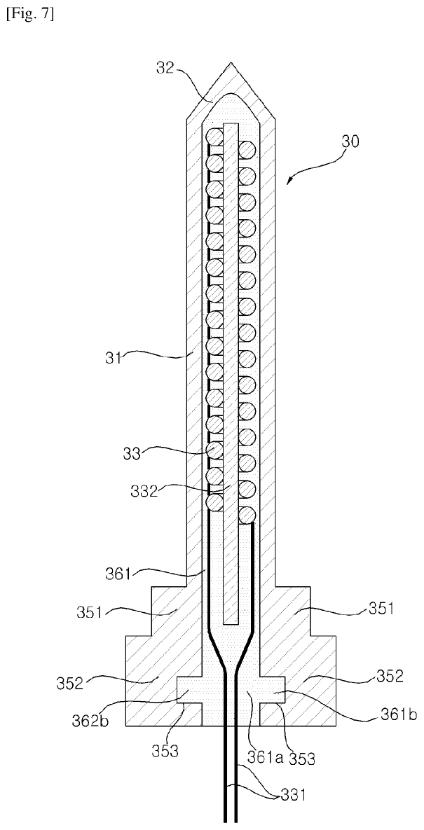

Referring further to FIG. 7, the material of the heater 33 may be selected in consideration of the TCR value. The higher the TCR value of the heater 33 is, the more the resistance value changes when the heater 33 generates heat, making it difficult to maintain a constant setting and taste. By contrast, the lower the TCR value of the heater 33 is, the less the resistance value changes when the heater 33 generates heat using a voltage applied thereto, allowing a target temperature to be more accurately reached. To this end, the TCR value of the heater 33 may be set to 1500 ppm/°C or less. Thus, the temperature of the heater 33 may be accurately controlled or maintained, and the temperature of the heater 33 may be accurately sensed. Also, stable taste may be provided to a user.

The heater 33 may include the aforementioned austenitic stainless steel. Alternatively, the heater 33 may include any one of the aforementioned brass, nichrome, kanthal, constantan, and manganin. In this case, the heater 33 may have a TCR value of 2 ppm/°C to 1100 ppm/°C.

Referring to FIG. 9, graphs of FIG. 9 show changes in heater temperature when applying a voltage to cause a heater of a specific material to generate heat repeatedly with a target temperature of 326 °C. Here, an experiment was conducted by repeating a process of applying a voltage to the heater to cause the heater to generate heat with a target temperature of 326 °C and applying a voltage again at intervals of several seconds to cause the heater to generate heat. The x-axis is the number of repetitions, and the y-axis is the temperature (C) of the heater. In (a) of FIG. 9, the experiment was conducted on copper with a TCR value of 3900 ppm/°C, and in (b) of FIG. 9, the experiment was conducted on 316L stainless steel with a TCR value of 920 ppm/°C. It can be seen that as heat generation of the heaters is repeated, the temperature of 316L stainless steel stays closer to the target temperature, whereas the temperature of copper rises above the target temperature.

Referring to FIGS. 1 to 9, an aerosol generating device according to one aspect of the present disclosure includes: a body comprising an insertion space having an opening to allow a stick to be inserted therein; a heater pin protruding from an end of the insertion space toward the opening and configured to be inserted into the stick that is inserted into the insertion space; and a heater disposed in a cavity of the heater pin and configured to heat the heater pin for heating the stick inserted into the insertion space., The heater is formed of a material that has a temperature coefficient of resistance (TCR) value of 1500 ppm/°C or less.

The heater may include austenitic stainless steel.

The heater may include 316L stainless steel.

The heater may include any one of 301 stainless steel, 301L stainless steel, 304 stainless steel, 304L stainless steel, 314L stainless steel, 316 stainless steel, 317 stainless steel, and 317L stainless steel.

The heater may include any one of brass, nichrome, kanthal, constantan, and manganin.

The TCR value of the material of the heater is in a range of 2 ppm/°C to 1100 ppm/°C.

The cavity and the heater may be elongated along a longitudinal direction of the heater pin.

The heater may wound around an elongated support bar that is inserted into the cavity.

The support bar may include aluminum oxide.

The aerosol generating device may further include a bonding material to fill the cavity, so as to fix the heater to the heater pin.

The bonding material may be a ceramic bonding agent.

The ceramic bonding agent may include an alumina ceramic.

The heater pin may include zirconia.

An aerosol generating device according to another aspect of the present disclosure includes: a body comprising an insertion space having an opening to allow a stick to be inserted therein; a heater pin protruding from an end of the insertion space toward the opening and configured to be inserted into the stick that is inserted into the insertion space; a heater wound around an elongated support bar that is inserted into a cavity of the heater pin, wherein the heater is configured to heat the heater pin for heating the stick inserted into the insertion space; and a bonding material injected into the cavity so as to fix the support bar and the heater to the heater pin. The heater pin may be formed of zirconia, the bonding material may be a ceramic bonding agent including an alumina ceramic, the support bar may be formed of aluminum oxide, and the heater may be formed of 316L stainless steel.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body comprising an insertion space having an opening to allow a stick to be inserted therein;
a heater pin protruding from an end of the insertion space toward the opening and configured to be inserted into the stick that is inserted into the insertion space; and
a heater disposed in a cavity of the heater pin and configured to heat the heater pin for heating the stick inserted into the insertion space,
wherein the heater is formed of a material that has a temperature coefficient of resistance (TCR) value of 1500 ppm/°C or less.

2. The aerosol generating device of claim 1, wherein the heater comprises austenitic stainless steel.

3. The aerosol generating device of claim 2, wherein the heater comprises 316L stainless steel.

4. The aerosol generating device of claim 2, wherein the heater comprises any one of 301 stainless steel, 301L stainless steel, 304 stainless steel, 304L stainless steel, 314L stainless steel, 316 stainless steel, 317 stainless steel, and 317L stainless steel.

5. The aerosol generating device of claim 1, wherein the heater comprises any one of brass, nichrome, kanthal, constantan, and manganin.

6. The aerosol generating device of claim 1, wherein the TCR value of the material of the heater is in a range of 2 ppm/°C to 1100 ppm/°C.

7. The aerosol generating device of claim 1, wherein the cavity and the heater are elongated along a longitudinal direction of the heater pin.

8. The aerosol generating device of claim 7,
wherein the heater is wound around an elongated support bar that is inserted into the cavity.

9. The aerosol generating device of claim 8, wherein the support bar comprises aluminum oxide.

10. The aerosol generating device of claim 1, further comprising a bonding material to fill the cavity, so as to fix the heater to the heater pin.

11. The aerosol generating device of claim 10, wherein the bonding material is a ceramic bonding agent.

12. The aerosol generating device of claim 11, wherein the ceramic bonding agent comprises an alumina ceramic.

13. The aerosol generating device of claim 1, wherein the heater pin comprises zirconia.

14. An aerosol generating device comprising:
a body comprising an insertion space having an opening to allow a stick to be inserted therein;
a heater pin protruding from an end of the insertion space toward the opening and configured to be inserted into the stick that is inserted into the insertion space;
a heater wound around an elongated support bar that is inserted into a cavity of the heater pin, wherein the heater is configured to heat the heater pin for heating the stick inserted into the insertion space; and
a bonding material injected into the cavity so as to fix the support bar and the heater to the heater pin,
wherein the heater pin is formed of zirconia,
wherein the bonding material is a ceramic bonding agent comprising an alumina ceramic,
wherein the support bar is formed of aluminum oxide, and
wherein the heater is formed of 316L stainless steel.
